(19) United States
(12) Patent Application Publication
(10) Pub. No.: US 2005/0048944 A1
(43) Pub. Date: Mar. 3, 2005

(54) Wireless remotely controlled electronic equipment and the connecting devices for the same

(76) Inventor: Jeng-Shyong Wu, Hsinchu (TW)

Correspondence Address: MCGLEW & TUTTLE, PC, 1 SCARBOROUGH STATION PLAZA, SCARBOROUGH, NY, 10510-0827, US

(21) Appl. No.: 10/653,074

(22) Filed: Sep. 2, 2003

(51) Int. Cl. H04B 1/00

(52) U.S. Cl. 455/344; 455/130

(57) ABSTRACT

A wireless remotely controlled electronic equipment and its connecting devices is disclosed, it comprises an insulation box to accommodate the electronic equipment therein to protect the electric security, several connecting devices for interconnecting power supply to light load, a receiver unit for receiving wireless command signals from an external transmitter; and a function controller for performing a variety of functions according to the received wireless command signals. With this scheme, when the equipment is energized by an input from the power source, the wireless command signals received by the receiver unit are transmitted to the function controller so that the function controller is actuated to perform predetermined single or a variety of functional operations and output the resultant command signals to the connected light load so as to cause the connected light load to display a variety of blinking effects.

### BACKGROUND OF THE INVENTION

1. Field of the Invention

The present invention relates to wireless remotely controlled electronic equipment and the connecting devices for the same. In particular, it is an electronic equipment with associated connecting devices in case the receiver unit of this equipment receives wireless command signals from an external transmitter when the equipment is energized by a power source, a function controller contained in this equipment is able to start to perform predetermined single or a variety of functional operations and output the resultant command signals to the connected light loads so as to cause the connected light loads to exhibit a variety of predetermined blinking effects.

2. Description of the Prior Art

As the blinking light strings may serve twinkling star-like effect in the night time, they are the favorable decorative lighting equipment where the accent lighting atmosphere is particularly desirous such as in festivals or for commercial advertisements. In consideration of electrical security, the connected light string loads to a power source should be proper in amount so as to avoid overheat or even burn down of conductors due to insufficient current carrying capacity. In the early years, in order to palliate the danger of overloading, the light strings connected in series were arranged to be energized section by section resulting in failing to exhibit an unanimous twinkling effect of all light strings thereby seriously degrading the rejoicing atmosphere. For a remedy, it was tried to use larger sized conductors or increase the capacity of the controller so as to allow increasing the number of the light strings connected in one circuit. But soon it was found that the installation cost was too high, moreover, all light strings became dark in occurrence of a failure of broken conductor, and worse to worst, it had to accompany a costy repairing work.

A fairly progressive solution was disclosed by U.S. Pat. No. 5,854,541 in which a controller is provided to a string of lights, the controller input terminal is connected to an external power source. The output terminal of a trigger circuit included in the controller is connected to the aforesaid light string, one terminal of the trigger circuit is reserved for catching the incoming oscillation command signals for ON/OFF control of the trigger circuit such that the lights on the light string are caused to blink according to the incoming command signals. A plurality of identical unit light string connected in parallel with each other are then connected to the trigger circuit of the controller. With this structure, all lights in this system can blink simultaneously without need for bigger-sized conductors to prevent overloading.

However, the light strings constructed as such are not easy to distribute the light strings over a broad area because it is necessary to connect unit light string one by one in parallel with each other which restricts extendable length of the circuit. Besides, the way of diode rectification which turns on the light loads during either positive or negative half wave can only cause a monotonous blinking effect, but cannot provide more variable and vivid twinkling effect. Furthermore, if the layout of the light strings is intended to extend widely, it has to depend on an inconvenient pilot wire.

### SUMMARY OF THE INVENTION

Aiming at the above depicted shortcoming inherent to the prior arts, the present inventor has delved in this matter for a long time efforts and finally succeeded in realizing this invention.

It is an object of the present invention to provide an electronic equipment and its associated connecting devices which can be remotely controlled by wireless command signals so as to obtain a variety of blinking effects from the connected light strings.

It is another object of the present invention to include a function controller and a receiver unit which can be separately installed or integrally installed together without affecting variability of blinking effects of the connected light strings.

To achieve the above mentioned objects, the present invention comprises an insulation box to accommodate the electronic equipment therein and protect its electrical security; several connecting devices for interconnecting power supply and light load; a receiver unit for receiving wireless command signals from an external transmitter; and a function controller for performing a variety of functions according to the received wireless command signals. With this scheme, when the present invention is energized by an input from the power source, the wireless command signals received by the receiver unit are transmitted to the function controller so that the function controller is actuated to perform predetermined single or a variety of functional operations and output the resultant command signals to the connected light load so as to cause the connected light load to display a variety of blinking effects.

To enable a further understanding of the innovative and technological content of the invention herein, refer to the detailed description of the invention and the accompanying brief description of the drawings appended below.

### BRIEF DESCRIPTION OF THE DRAWINGS

FIG. 1 is a cross-sectional view of the present invention;

FIG. 2 is the circuit diagram of the present invention;

FIG. 3 is a view illustrating a second embodiment of the present invention;

FIG. 4 is a view illustrating a third embodiment of the present invention;

FIG. 5 is a view illustrating a fourth embodiment of the present invention;

FIG. 6 is a view illustrating a fifth embodiment of the present invention;

FIG. 7 is a view illustrating a sixth embodiment of the present invention;

FIG. 8 is a view illustrating a seventh embodiment of the present invention;

FIG. 9 is a view illustrating an eighth embodiment of the present invention.

### DETAILED DESCRIPTION OF THE PREFERRED EMBODIMENTS

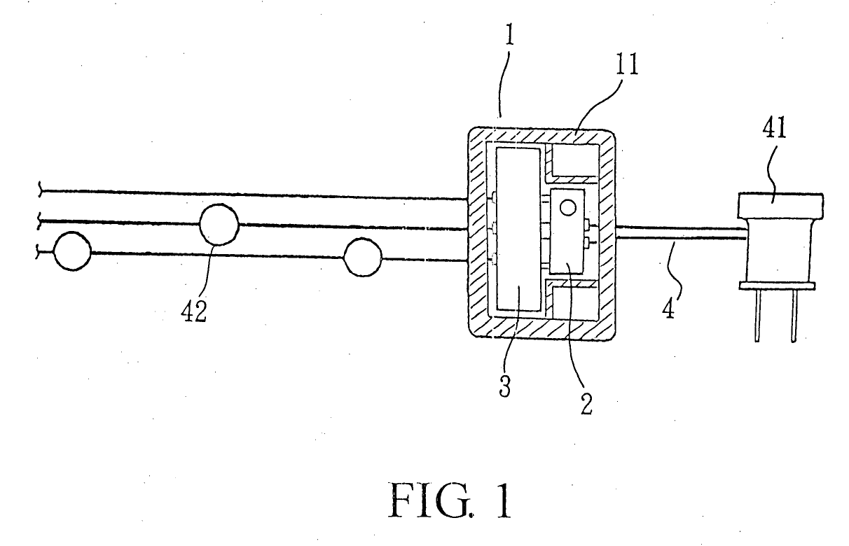

Referring to FIG. 1, the cross sectional view of the present invention, in which it is shown that the present invention comprises an insulation box 1, a receiver unit 2, a function controller 3, and one or more than 1 connecting devices 4.

The insulation box 1 provides electrical security with its insulated framework 11 for the electronic equipment from an input side to an output side.

The receiver unit 2 is accommodated in the insulation box 1 for receiving incoming wireless command signals transmitted from outside.

The function controller 3 also accommodated in the insulation box 1, is connected with the receiver unit 2 for performing a variety of functions according to the wireless command signals received by the receiver unit.

The connecting device 4 is formed of a group of electric conductors which are extended out of the insulation box 1 to connect to a power supply with an AC electric plug 41, and to connect to the electronic equipment accommodated in the insulation box 1 and a plurality of light string loads 42 connected in series, parallel, or series-parallel.

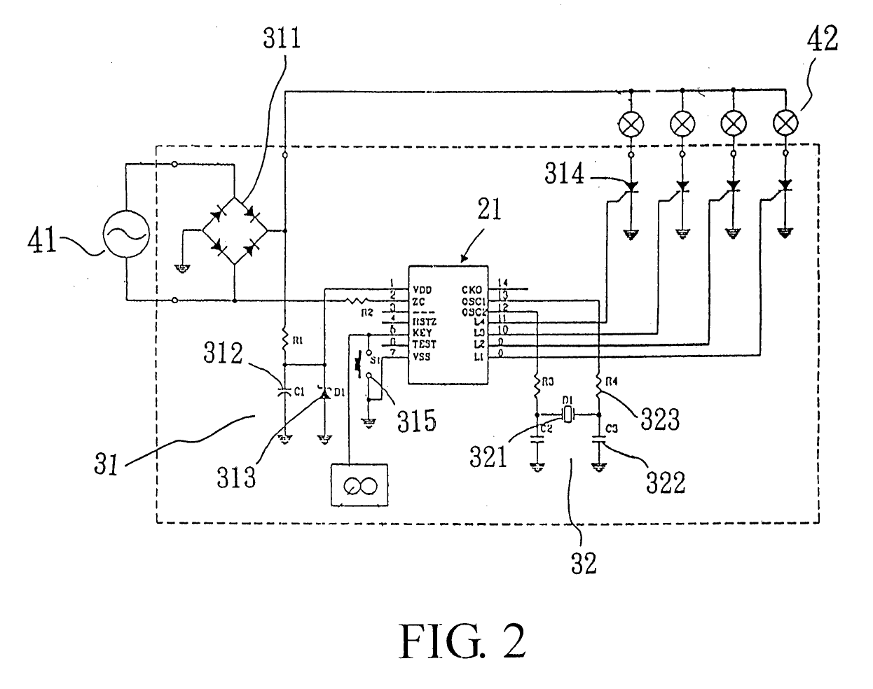

Referring to FIG. 2, a schematic diagram for the circuit of the present invention the receiver unit 2 is essentially composed of an IC unit 21 and some of the auxiliary electronic component. The IC unit obtains the power supply from an AC power source and receives incoming wireless command signals and transfer the same to the function controller 3. The receivable wireless command signals include: infrared ray waves and microwaves, and their intensity, quantity and quality are adjustable, changeable, controllable and switchable.

The function controller 3 shares the use of the IC unit 21 with the receiver unit 2, and has auxiliary components 31 in addition. The auxiliary components 31 include a rectifier 311, a capacitor 312, a voltage stablorizing diode 313, a SCR 314, and a switch 315 so as to perform variation, adjustments, staborizing promotion, initiation, and protection of the equipment.

The function controller 3 also has a synchronous control circuit 32 which is composed of a quartz oscillator 321 a capacitor 322, and a resistor 23, and is connected with the IC unit 21 to form an oscillator circuit for providing a reference frequency for the equipment to operate according to a predetermined function.

It is not an important matter whether the IC unit has a memory ability or not, but it is absolutely necessary that all the light strings keep pace with one another in operation as soon as they are energized from a similar AC power source and receive the same command signals from the same signal transmission line so that their AC waveforms are rectified into an identical DC with a specific waveform and frequency and is inputted into the IC unit 21 as a reference value of waveform and frequency. This reference value is used to modify and adjust the deviation arising from the difference of characteristics between the quartz oscillator 321 and associated auxiliary component during the chopped time interval of the trigger circuit. In this way, the unanimous blinking effect for all light strings can be achieved through transmitting the control signals firm the IC unit 21 widely to all directions without requiring extra pilot wires.

The sequence of operation can be clearly observed on FIG. 2, the equipment is energized by inserting the AC plug 41 to the power source, the receiver unit receives incoming signals and then causes the function controller 3 to start performing the predetermined either a single, or a variety of functional operations such that the resultant output of the function controller 3 makes the connected light string loads to display a variety of predetermined blinking effects.

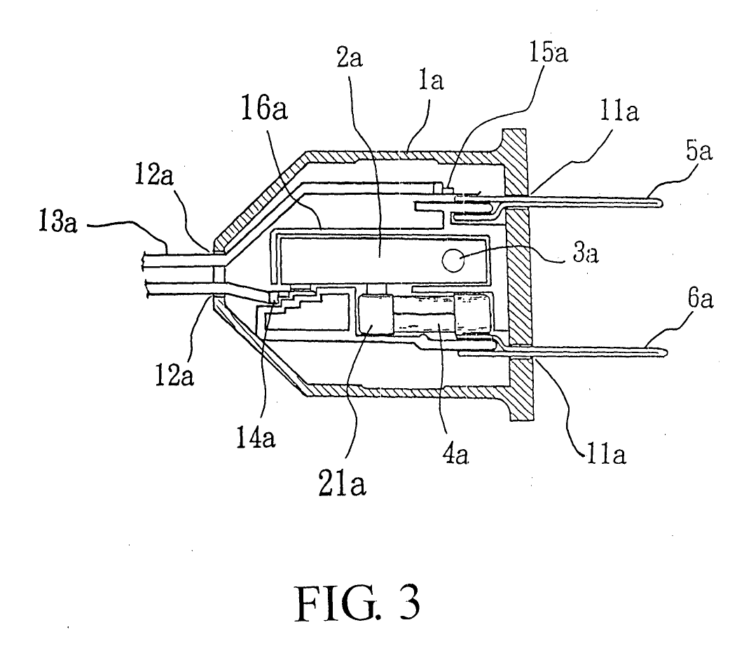

In the second embodiment shown in FIG. 3, an insulation box 1a is encircled by a standing wall, a couple of blade insertion holes 11a are provided on the front wall for insertion of a couple of connecting blades 5a an 6a. On the other hand, a via hole 12a is provided through the rear wall for introducing a two core insulated conductor 13a having two terminals 14a, 15a to enter the insulator box 1a. The inner cavity of the insulation box 1a is parted with several pieces of barrier 16a into a plurality of isolated chambers for accommodating receiver and control units. A receiver and control unit 2a has a signal receiving section 3a with a fusing device 4a provided at one side thereof for protecting overcurrent of circuit within a preset limit of the safety current. The fusing device 4a contacts a contact portion 21a of the receiver and control unit 2a via a reserver hole on its housing. Another contact portion of the receiver and control unit 2a is connected with the terminal 14a of the two core insulated conductor 13a. The tails of the above mentioned connecting blades 5a and 6a are biforked for inlaying and fixing the barrier 16a thereat. One of the prong of the biforked blade 5a is in connection with the terminal 15a, while one prong of the other blade 6a is in contact with the fusing device 4a. Meanwhile, the number of insulated conductors depend on the necessary input and output electrical circuits.

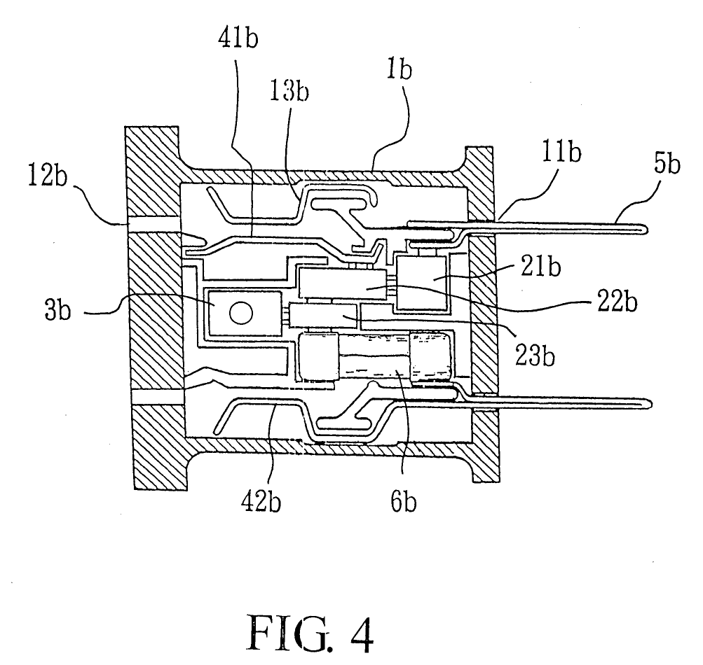

Referring to FIG. 4, in the third embodiment of the present invention, a couple of blade holes 11b is provided on the front wall of an insulation box 1b, while on the real wall thereof a couple of insertion holes 12b are provided for blades leading to the load to insert. The inner cavity of the insulation box 1b is sectioned by several barriers 13b for accommodation of a plurality of function controllers 21b, 22b, 23b having similar or different function control ability. One of them, i.e. 23b is connected to a receiver unit 3b. The waist portions of the insertion blades 12b are rested on and fixed to the front wall of the insulation box 1b. The tips of the blades are emerged out of the front wall to connect the power source, while the rear connector blades are contained in the insulation box 1b. One of the blades has a breached tail to trammel one of the barriers 13b, and is further in connection with the function controller 21b. The other blade is connected with the load terminal near the exit of the blade hole 11b. The connection blades are the electric connectors with their waist portions served as contact portions to electrically in contact with the equipment.

An interconnection blade 41b is interposed separately between rear load connector blade and front source blade. The interconnection blades 41b has a contact portion to contact the contact portion of the receiver unit or the function controller. The interconnection blade 41b is bent into a proper configuration to mate the blades 5b. There is a fusing device 6b in connection with the function controller 23b.

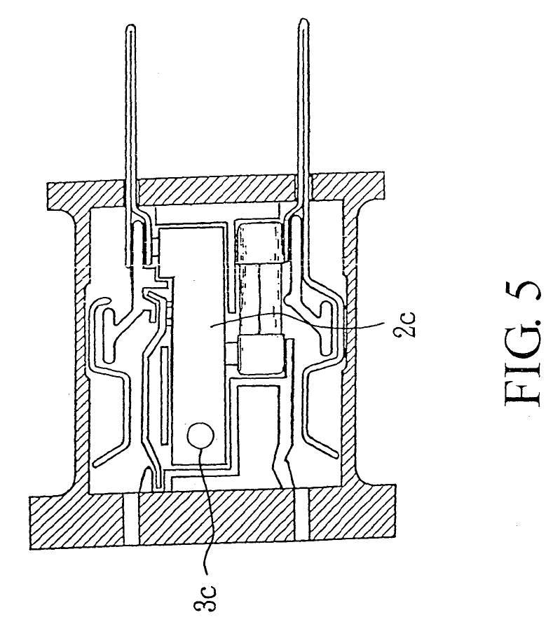

Referring to FIG. 5, in the fourth embodiment of the present invention, it is different from the third embodiment shown in FIG. 4 in that a synthetic function controller 2C is employed instead of the individual one used in the former embodiment, and a receiver 3C is installed at one side of the synthetic function controller 2C, whereas both are entrained on a PCB.

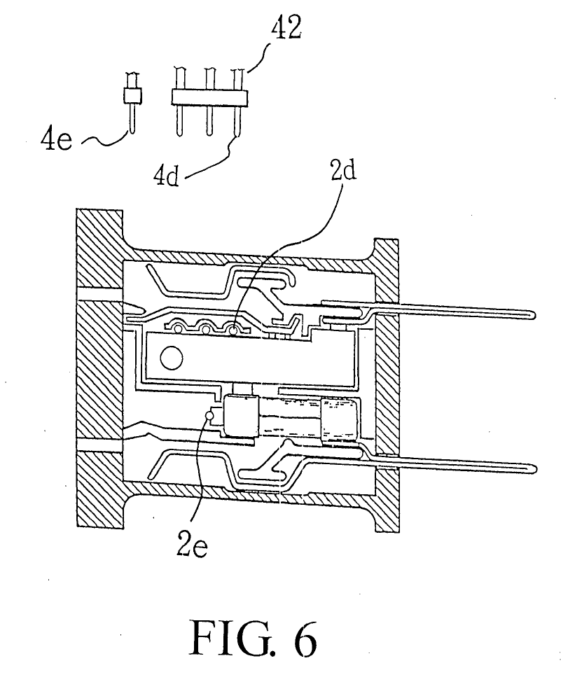

Referring to FIG. 6, in the fifth embodiment of the present invention, several receptable holes 2d are provided at the contact portion of the receiver unit or the function controller, the receptable holes 2d are aligned to preserved corresponding holes provided on the insulation box for inserting connector pins 4d for supplying power to load. Besides, another receptable hole 2e is provided at the contact portion of the fusing device so as to accept insertion of another connector pin 4e serving as another pole terminal.

In the connecting devices of the present invention, the holes provided on the rear wall of the output sides thereof and connector blades provided inside allow mutually mating connecting devices of similar function for performing a variety of functional operations, or allow mating connecting devices of different function for performing furthermore functional operations. Meanwhile, above mentioned holes and inner connector blades allow mating plugs for load connection.

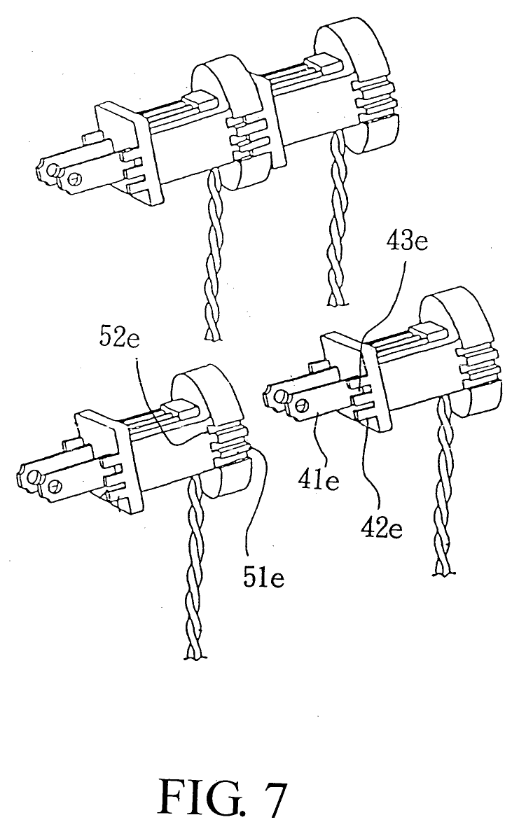

In the sixth embodiment of the present invention shown in FIG. 7, discrimination means for refusing mating of incompatible connecting devices is provided in the form of tenon and mortise joint. As shown in FIG. 7, at both sides of a couple of blades 41e for an AC plug are accompanied with several stub tenons 42e and several slot mortises 43e each interposed between two adjacent stub tenons 42e. The stub tenon 42e is formed of an electrically insulation material and extended parallel to moving direction of the plug should the tenon (51e) and mortise (52e) joint provided for another connecting device be completely coincident with the former tenon (42e) and moitise (43e) joint in size, position, and number, the two connecting devices are compatible and entitled to mate with each other. Otherwise, any two connecting devices which cannot fulfill the aforesaid condition will be considered incompatible and refused to mate with each other.

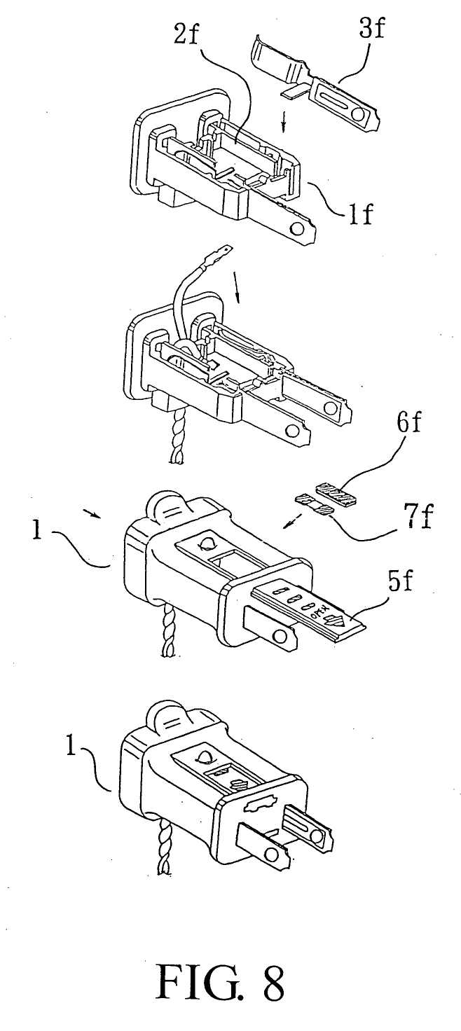

In the seventh embodiment of the present invention shown in FIG. 8, an inner entrainer If with several barriers 2f is provided in the insulation box 1, the barriers 2f divide the inner cavity of box 1 into several isolated chambers for setting component devices such as fixed blades 3f, a receiver unit and function controller 6f and a fusing device 7f An upper opendable slide lid 5f is provided, which is appropriately formed to match the position of blade holes and the component devices entrained on the entraier If so as to facilitate replacement of the component parts 6f and 7f by opening the lid 5f.

The receiver unit and function controller and associated component parts can be separately assembled on an individual PCB, or assembled on the same PCB in combining form. It may as well reserve a contact portion on PCB for connection of other devices. The receiver unit and the function controller may individually be packed with an insulation material, or incorporatively packed in one unit. The insulated package shall reserve an exposed contact portion for connection of other connecting devices. The receiver unit and the function controller are detachably installed in the insulation box for replacement. The signal receiving portion of the receiver unit is emerged out of the insulation box via the reserved hole so as to receive the command signals easily. The receiver unit and the function controller may be integrally combined in one piece.

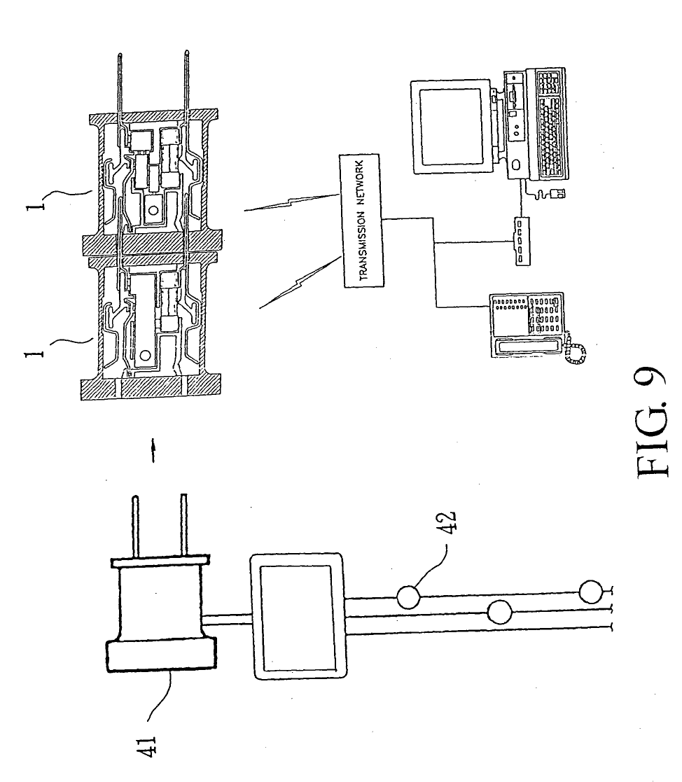

Referring to FIG. 9, in this eighth embodiment of the present invention, the receiver unit can receive those command signals from various existing wireless transmitter sources such as a computer, a wireless mouse, a wireless key board, a wireless internet, and its distributed terminals, a wireless Internet card, a cellular phone, and the receiver unit has an encoder and a decoder.

Those who are skilled in the art will readily perceive how to modify the invention. Therefore, the appended claims are to be construed to cover all equivalent structures which fall within the true scope an spirit of the invention.

1. Wireless remotely controlled electronic equipment and the connecting devices for the same, said electronic equipment being accommodated in an insulation box, and said connecting devices for interconnecting an input power source and an output of said electronic equipment to load side, comprising: said insulation box for providing electrical security with its insulated framework for said electronic equipment from an input side to an output side; said connecting devices for connecting a power supply to said electronic equipment, and connecting the output therefrom to load sides: a receiver unit included in said electronic equipment for receiving incoming wireless command signals from external transmitters; and a function controller included in said electronic equipment for performing a variety of functional effects according to said wireless command signals received by said receiver unit; wherein when said electronic equipment is energized by the power source, said receiver unit receives incoming wireless command signals from external transmitters and actuates said function controller to perform single or a variety of predetermined display erects accordingly.

2. The electronic equipment and the connecting devices of claim 1, wherein said insulation box is encircled by a standing wall along its edges, and several via holes are drilled through said wall for letting output and input component parts for the equipment to pass through.

3. The electronic equipment and the connecting devices of claim 1, wherein the inner cavity of said insulation box is parted with several pieces of barrier into a plurality of isolated chambers for accommodating and setting said equipment together with the component parts.

4. The electronic equipment and the connecting devices of claim 1, wherein a group of insulated electric conductors are used to connect the output and the input sides by piercing through said holes provided on the wall of said insulation box, one end of each said conductor is connected to said equipment, while the other end thereof is extended out of said insulation box.

5. The electronic equipment and the connecting devices of claim 1, wherein the end of said conductor in said insulation box is connected to the equipment with a terminal.

6. The electronic equipment and the connecting devices of claim 4, wherein the number of said electric conductors is determined by the number of electrical circuits for input and output.

7. The electronic equipment and the connecting devices of claim 1, wherein several insertion blades are used to input power from the power source, wherein the plurality of insulated electric conductors are used for output to the load by piercing through said via holes formed on the wall of said insulation box to connect to the external blades for power supply and load connection, whereas in said insulation box, said conductors are in contact with the contact portion of each equipment.

8. The electronic equipment acid the connecting devices of claim 7, wherein the number of said electric conductors is determined by the number of output electrical circuits.

9. The electronic equipment and the connecting devices of claim 1, wherein several insertion blades are employed to connect with input and output, the waist portions of said insertion blades are rested on, and fixed to the front wall of said insulation box, the tips of said insertion blades are emerged out of said insulation box to connect the power source, whereas the rear connector blades are contained in said insulation box, and one of them is connected with the load terminal near said blade hole, said connection blades are the electric connectors with their waist portions electrically in contact with said electronic equipment.

10. The electronic equipment and the connecting devices of claim 9, wherein the contact portions of said insertion blades are directly connected with said insulation conductors leading to load.

11. The electronic equipment and the connecting devices of claim 9, wherein several receptacle holes are provided at the contact portion of said equipment, said receptacle holes are aligned to preserved corresponding holes provided on said insulation box for insulation box for insertion of connector pins for supplying power to the connected load.

12. The electronic equipment and the connecting devices of claim 9, wherein said connecting device for output and input connection is provided with an interconnection blade interposed separately between a rear load connection blade and a front source blade and having a contact portion to connect the contact portion of said receiver unit and said function controller.

13. The electronic equipment and the connecting devices of claim 1, wherein said via holes opened through the rear wall of said insulation box and said rear connector blades contained in said insulation box allow mutual mating with connecting devices of similar function forwards and backwards for performing a variety of functional operations.

14. The electronic equipment art the connecting devices of claim 1, wherein said via holes opened through the rear wall of said insulation box and said rear connector blades contained in said insulation box allow mutual mating with connecting devices of different function forwards and backwards for performing further various functional operations.

15. The electronic equipment and the connecting devices of claim 1, wherein said via holes opened through the rear wall of said insulation box and said rear connector blades contained in said insulation box allow insertion of, and mating with, any conventional plug for supplying power to the land.

16. The electronic equipment and the connecting devices of claim 1, wherein a discrimination means is provided for refusing incompatible mating of said receiver unit or said function controller, or in case, certain restriction of use is necessary.

17. The electronic equipment and the connecting devices of claim 1, wherein said discrimination means is provided in the form of tenon and mortise joint by forming several stub tenons and several slot mortises at both sides of said connecting device, each of said mortise slot is interposed between two adjacent stub tenons, if said tenon and mortise joint provided for a connecting device is completely coincident with that formed in another connecting device in size, position, and number, the two connecting devices are compatible and allowed to mate with each other, if not, they are considered to be incompatible.

18. The electronic equipment and the connecting devices of claim 1, wherein said receiver unit is essentially composed of an IC unit and some other auxiliary electric components.

19. The electronic equipment and the connecting devices of claim 18, wherein said receiver unit is able to receive a power supply and external wireless command signals so as to produce and transfer predetermined functional signals.

20. The electronic equipment and the connecting devices of claim 18, wherein said receiver unit is able to adjust, change, and control the intensity, quantity, and quality of said command signals, or switch over said command signals.

21. The electronic equipment and the connecting devices of claim 18, wherein a functional portion of said receiver unit is emerged out of said preserved via holes oil the wall of said insulation box so as to facilitate receiving external command signals.

22. The electronic equipment and connecting devices of claim 1, wherein said receiver unit has a contact portion to contact said connecting device and said function controller.

23. The electronic equipment and connecting devices of claim 1, wherein receivable wireless command signals for said receiver unit include infrared ray waves or microwaves.

24. The electronic equipment and connecting devices of claim 1, wherein said function controller is essentially composed of an IC unit and some other auxiliary electronic components.

25. The electronic equipment and connecting devices of claim 24, wherein said IC unit is able to produce the predetermined functions, or has the ability of transmitting command signals.

26. The electronic equipment and connecting devices of claim 24, wherein said auxiliary electronic components include a rectifier, a capacitor with a resistor, a voltage staborizing diode, a SCR or a switch so as to perform variation, adjustment, staborizing, promotion, initiation, and protection of said equipment.

27. The electronic equipment and connecting devices of claim 1, wherein said function controller has a predetermined synchronous control ability.

28. The electronic equipment and connecting devices of claim 27, wherein said synchronous control ability of said function controller is produced by combination of a quartz oscillator, a capacitor, and a resistor, and said combination unit is connected with said IC unit to form an oscillation circuit for providing a reference frequency for synchronous operation to operate and attain the predetermined effect.

29. The electronic equipment and connecting devices of claim 1, wherein said function controller has contact portion which is in contact with said connecting device or said receiver unit.

30. The electronic equipment and connecting devices of claim 1, wherein said receiver unit and said function controller are integrally conjoined in one piece.

31. The electronic equipment and connecting devices of claim 1, wherein said receiver unit and said function controller respectively have their own component parts which are respectively assembled on individual PCB, or share the salve PCB.

32. The electronic equipment and connecting devices of claim 31, wherein said PCB is preserved a contact portion to connect the other connecting devices.

33. The electronic equipment and connecting devices of claim 1, wherein said receiver unit and said function controller are respectively packed with all insulation material to form an individual package, or combined to integrally packed in one piece with an insulation material.

34. The electronic equipment and connecting devices of claim 33, wherein said insulation package emerges an exposed contact portion to connect other connecting devices.

35. The electronic equipment and connecting devices of claim 31, wherein said receiver unit and said function controller are detachably installed in said insulation box for facilitating replacement.

36. The electronic equipment and connecting devices of claim 35, wherein said insulation box is provided with an upper opendable slide lid whose position is appropriately in match with the reserved blade holes on the wall of said insulation box so as to facilitate replacement of the equipment.

37. The electronic equipment and connecting devices of claim 1, wherein an inner entrainer is provided in said insulation box for pre-assembling component devices and inserting the entire unit into said insulation box.

38. The electronic equipment and connecting devices of claim 37, wherein several barriers are provided on said inner entrainer to divide the inner cavity of said insulation box into several isolated chambers for settling said component devices.

39. Tile electronic equipment and connecting devices of claim 36, wherein the portions of said component devices installed on said inner entrainer are appropriately in match with said reserved blade holes on the wall of said insulation box and said upper opendable slide lid so as to facilitate replacement of said component devices.

40. The electronic equipment aid connecting devices of claim 1, wherein said receiver unit and said function controller reserve several contact portions for directly connecting with said insulation conductors to extend said insulation conductors out of said insulation box to the load.

41. The electronic equipment and connecting devices of claim 1, wherein said receiver unit and said function controller reserve several receptacle terminals in said insulation box at the positions in match with the blade holes provided on the wall of said insulation box for allowing insertion of plugs leading to the load terminals.

42. The electronic equipment and connecting devices of claim 41, wherein said receptacle terminals are configurated in a cylinder shape, while said plug terminals are configurated in a pin shape.

43. The electronic equipment and connecting, devices of claim 1, wherein a fusing device is installed between said power input connecting device and said receiver unit, or between said power input connecting device and said function controller for protecting the circuit from overcurrent with a preset limit of current carrying capacity.

44. The electronic equipment and connecting devices of claim 43, wherein said fusing device has a contact portion for connecting with a contact portion of said receiver unit or said function controller.

45. The electronic equipment and connecting devices of claim 43, wherein said fusing devices is concealed in said insulation box and located in the position matching with said blade holes reserved on the wall of said insulation box, or affixed to said upper opendable slide lid for facilitating replacement.

46. The electronic equipment and connecting devices of claim 1, wherein said receiver unit is able to receive signals sent from existing wireless signal transmitters.

47. The electronic equipment and connecting devices of claims 46, wherein said existing wireless signal transmitters are a computer, a wireless mouse, a wireless keyboard, a wireless internet, and its distributor, a wireless internet card, and a cellular phone.

48. The electronic equipment and connecting devices of claim 1, wherein said receiver unit has an encoder and a decoder.

49. The electronic equipment and connecting devices of claim 1, wherein the load connected to the output terminal of said connecting devices include electrical and electronic equipment and devices, or a plurality of light strings connected in series, parallel, or series parallel.

50. Wireless remotely controlled electronic equipment and the connecting devices for the same, said electronic equipment being accommodated in an insulation box, and said connecting devices for interconnecting an input power source and an output of said electronic equipment to load side, comprising:
said insulation box encircled by a standing wall along its front, rear and side edges, the inner cavity of said insulation box being parted into several isolated chambers with several barriers; and several insertion holes being reserved at front, rear, and side wall; said source input side connecting device being formed of a plurality of contact blades inserted into said front blade holes and fixed thereat, wherein one end of said blade is extended out of said insulation box to connect with the power supply source, while the other end thereof has a contact portion;
said receiver unit being composed of an IC unit or other auxiliary electronic components to receive external incoming wireless command signals and produce a predetermined function, wherein said receiver unit has a contact portion and is set in an isolated chamber of said insulation box;
said function controller being composed of an IC unit or other auxiliary electronic components to produce a predetermined functional effect or deliver command signals, wherein said function controller has a contact portion and is set in an isolation chamber of said insulation box;
said load output side connecting device being formed of a plurality of insulation electrical conductors, wherein said conductors are rested in the via holes provided at the rear wall of said insulation box; one end of each said conductors has a connector terminal placed in said insulation box, while the other end thereof is extended out of said insulation box to connect with the load;
wherein each said contact portion is connected to the circuit according to its functional effect, and the insertion blades are connected to die power source, when said receiver unit receives the extraneous incoming wireless command signal;
said receiver unit actuate said function controller to start working with a predetermined single or a variety of functions which are transferred to the load terminals for the load to display predetermined functional operations.

51. The electronic equipment and connecting devices of claim 50, wherein the contact portions of said insertion blades are directly connected with said insulation conductors leading to load.

52. The electronic equipment and connecting devices of claim 50, wherein said connecting device for output and input connection is provided with an interconnection blade interposed separately between a rear load connection blade and a front source blade and having a contact portion to connect the contact portion of said receiver unit or said function controller.

53. The electronic equipment and connecting devices of claim 50, wherein said via holes opened through the rear wall of said insulation box and said rear connector blades contained in said insulation box allow mutual mating with connecting devices of similar function forwards and backwards for performing a variety of functional operations.

54. The electronic equipment and the connecting devices of claim 50, wherein said via holes opened through the rear wall of said insulation box and said rear connector blades contained in said insulation box allow mutual mating of connecting devices of different function forwards and backwards for performing further various functional operations.

55. The electronic equipment and the connecting devices of claim 50, wherein said via holes opened through the rear wall of said insulation box and said rear connector blades contained in said insulation box allow insertion of, and mating with, any conventional plug for supplying power to the load.

56. The electronic equipment and the connecting devices of claim 50, wherein receivable wireless command signals for said receiver unit include infrared ray waves or microwaves.

57. The electronic equipment and the connecting devices of claim 50, wherein said receiver unit and said function controller are integrally conjoined in one piece.

58. The electronic equipment and the connecting devices of claim 50, wherein said receiver unit and said function controller are detachably installed in said insulation box for facilitating replacement.

59. The electronic equipment and the connecting devices of claim 50, wherein said receiver unit and said function controller reserve several contact portions for directly connecting with said insulation conductors to extend said conductors out of said insulation box to the load.

60. The electronic equipment and the conducting devices of claim 50, wherein a fusing device is installed between said power input connecting device and said function controller for protecting the circuit from overcurrent with a preset limit of safety current carrying capacity.

61. Wireless remotely controlled electronic equipment and the connecting devices of the same, said electronic equipment being accommodated in an insulation box, and said connecting devices for interconnecting an input power source and all output of said electronic equipment to load side comprising:
said insulation box encircled by a standing wall along its front, rear and side edges, the inner cavity of said insulation box being parted into several isolated chambers with several barriers and several insertion holes being reserved at front, rear, and side wall;
said connecting device being formed of a plurality of contact blades with their waist portions inserted and rested on said front holes, the front blades being extended out of said insulation box for connecting to a power source, while rear connecting blades being placed in said insulation box and extending their rear ends near said rear insertion holes of said insulation box to connect with the load side insertion blades, wherein their waist portions serve as contact portions;
a receiver unit belonging to a part of said electronic equipment being composed of an IC unit or other auxiliary electronic components to receive external incoming wireless command signals and produce a predetermined function, wherein said receiver unit has a contact portion and set in an isolated chamber of said insulation box;
a function controller belonging to a part of said electronic equipment being composed of an IC unit or other auxiliary electronic components to produce a predetermined functional effect, or deliver command signals, wherein said function controller has a contact portion and is set in an isolation chamber of said insulation box;
wherein each of said contact portions connected with electrical circuits in the manner that insertion blades are connected with the power source, when said receiver unit receives external incoming wireless command signals, said signals are transferred to said function controller to initiate a predetermined single or a variety of functional operations which are transmitted to connected load from the output terminal so as to cause the load to display a predetermined variation effect.

62. The electronic equipment and connecting devices of claim 61, wherein the contact portions of said insertion blades are directly connected with said insulation conductors leading to load.

63. The electronic equipment and connecting devices of claim 61, wherein said connecting device for output and input connection is provided with an interconnection blade interposed separately between a rear load connection blade and a front source blade and having a contact portion to connect the contact portion of said receiver unit or said function controller.

64. The electronic equipment and connecting devices of claim 61, wherein said via holes opened through the rear wall of said insulation box and said rear connector blades contained in said insulation box allow mutual mating with connecting with connecting devices of similar function forwards and backwards for performing a variety of functional operations.

65. The electronic equipment and connecting devices of claim 61, wherein said via holes opened through the rear wall of said insulation box and said rear connector blades contained in said insulation box allow mutual mating with connecting devices of different functions forwards and backwards for performing further various functional operations.

66. The electronic equipment and connecting devices of claim 61, wherein said via holes opened through the rear wall of said insulation box and said rear connector blades contained in said insulation box allow insertion of, and mating with, any conventional plug for supplying power to the load.

67. The electronic equipment and connecting devices of claim 61, wherein receivable wireless command signals for said receiver unit include infrared ray waves or microwaves.

68. The electronic equipment and the connecting devices of claim 61, wherein said receiver unit and said function controller are integrally conjoined in one piece.

69. The electronic equipment and the connecting devices of claim 61, wherein said receiver unit and said function controller are detachably installed in said insulation box for facilitating replacement.

70. The electronic equipment and the connecting devices of claim 61, wherein said receiver unit and said function controller reserve several contact portions for directly connecting with said insulation conductors to extend said conductors out of said isolation box to the load.

71. The electronic equipment and tile connecting devices of claim 61, wherein a fusing device is installed between said power input connecting device and said function controller for protecting the circuit from overcurrent with a preset limit of safety current carrying capacity.
